(19) United States
(12) Patent Application Publication
(10) Pub. No.: US 2017/0139991 A1
(43) Pub. Date: May 18, 2017

(54) DYNAMIC QUERY PLAN BASED ON SKEW

(71) Applicant: LinkedIn Corporation, Mountain View, CA (US)

(72) Inventors: Nikhil Teletia, Santa Clara, CA (US); Srinath Shankar, Mountain View, CA (US); Scott M. Meyer, Berkeley, CA (US)

(73) Assignee: LINKEDIN CORPORATION, Mountain View, CA (US)

(21) Appl. No.: 14/942,862

(22) Filed: Nov. 16, 2015

(51) Int. Cl. G06F 17/30

(52) U.S. Cl. CPC G06F 17/30466; G06F 17/30463; G06F 17/30958

(57) ABSTRACT

A system obtains desired information from a database by dynamically modifying a query plan while executing a query against the database. In particular, the system accesses predefined cardinality information associated with the query for the database (such as a number of occurrences of information associated with the query in the database), and identifies query constraints based on the predefined cardinality information. Then, the system determines an initial query plan based on the query constraints. After executing an initial query against the database based on the initial query plan, the system revises the initial query and the initial query plan, based on partial results of the initial query, to produce a revised query and a revised query plan. Next, the system executes the revised query against the database based on the revised query plan to obtain additional partial results, and the operations are repeated until a total result is obtained.

### CROSS-REFERENCE TO RELATED APPLICATIONS

This application is related to: U.S. Non-Provisional application Ser. No. 14/858,178, entitled “Graph-Based Queries,” by Srinath Shankar, Rob Stephenson, Andrew Carter, Maverick Lee and Scott Meyer (Attorney Docket No. LI-P1664.LNK.US), filed on Sep. 18, 2015; U.S. Non-Provisional application Ser. No. 14/858,192, entitled “Concatenated Queries Based on Graph-Query Results,” by Srinath Shankar, Rob Stephenson, Andrew Carter and Scott Meyer (Attorney Docket No. LI-P1665.LNK.US), filed on Sep. 18, 2015; U.S. Non-Provisional application Ser. No. 14/858,208, entitled “Verifying Graph-Based Queries,” by Yejuan Long, Srinath Shankar and Scott Meyer (Attorney Docket No. LI-P1666.LNK.US), filed on Sep. 18, 2015; U.S. Non-Provisional application Ser. No. 14/858,213, entitled “Translating Queries into Graph Queries Using Primitives,” by Srinath Shankar, Huaxin Liu, Rob Stephenson and Scott Meyer (Attorney Docket No. LI-P1667.LNK.US), filed on Sep. 18, 2015; U.S. Non-Provisional application Ser. No. 14/858,225, entitled “Representing Compound Relationships in a Graph Database,” by Shyam Shankar, Karan Parikh, Andrew Carter, Scott Meyer and Srinath Shankar (Attorney Docket No. LI-P1668.LNK.US), filed on Sep. 18, 2015; and U.S. Non-Provisional application Ser. No. ______, entitled “Message Passing in a Distributed Graph Database,” by Yongling Song, Andrew Carter, Joshua Ehrlich and Scott Meyer (Attorney Docket No. LI-P1669.LNK.US), filed on ______, 2015, the contents of each of which are herein incorporated by reference.

### BACKGROUND

Field

The described embodiments relate to techniques for performing a query of a database. More specifically, the described embodiments relate to techniques for dynamically modifying a query plan based on partial results obtained by executing a query against a database.

Related Art

Data associated with applications is often organized and stored in databases. By executing a query from an application against a database, desired information can be obtained and returned to the application.

However, there can be a significant difference in the time it takes to obtain results for different queries or for a particular query, depending on how the query is executed against a database (which is sometimes referred to as a ‘query plan’). In particular, a database may have very different amounts of content associated with different aspects of a query (which is referred to as ‘skew’). For example, the results for a query for the followers of Bob Ridley in a social networking application may include millions of individuals, while the results for a query for the followers of John Smith may be a few dozen people. Consequently, these queries will take very different amounts of time to execute.

One approach for addressing skew is to estimate the size of the results for a particular query in advance using a lookup table with predefined information about the content in a database. However, this approach suffers from several difficulties. Notably, the information in the lookup table may be incomplete or inaccurate. For example, as the database is changed, the lookup table usually is not updated immediately. Furthermore, even if a lookup table includes entries for different content, it typically does not include all the permutations or combinations that can occur in queries. Thus, there may be information about the followers of Bob Ridley and how many people live in New York City, but a query for the number of followers of Bob Ridley who live in New York City may not be included in the lookup table.

Consequently, a query plan that is determined based on a lookup table is often inaccurate and, because the query plan is determined in advance, it is also inflexible and cannot be adapted as more accurate information becomes available. These limitations can adversely impact the performance of the database and associated applications, which can degrade the user experience.

### BRIEF DESCRIPTION OF THE FIGURES

FIG. 1 is a block diagram illustrating a system in accordance with an embodiment of the present disclosure.

FIG. 2 is a block diagram illustrating a graph in a graph database in the system of FIG. 1 in accordance with an embodiment of the present disclosure.

FIG. 3 is a block diagram illustrating communication within the graph database in the system of FIG. 1 in accordance with an embodiment of the present disclosure.

FIG. 4 is a flow chart illustrating a method for requesting desired information from a graph database in the system of FIG. 1 in accordance with an embodiment of the present disclosure.

FIG. 5 is a drawing illustrating interaction with a graph database in the system of FIG. 1 in accordance with an embodiment of the present disclosure.

FIG. 6 is a block diagram illustrating a computer system that performs the method of FIG. 4 in accordance with an embodiment of the present disclosure.

Table 1 provides data in JavaScript Object Notation (JSON) in accordance with an embodiment of the present disclosure.

Table 2 provides an edge query in accordance with an embodiment of the present disclosure.

Table 3 provides a result for an edge query in accordance with an embodiment of the present disclosure.

Table 4 provides an edge query in accordance with an embodiment of the present disclosure.

Table 5 provides an edge query and associated predefined cardinality information in accordance with an embodiment of the present disclosure.

Table 6 provides an output for an index lookup for the edge query of Table 5 in accordance with an embodiment of the present disclosure.

Table 7 provides an output for an index lookup for the edge query of Table 5 in accordance with an embodiment of the present disclosure.

Table 8 provides a final output for the edge query of Table 5 in accordance with an embodiment of the present disclosure.

Table 9 provides a cost of the non-skew strategy shown in Tables 5-8 in accordance with an embodiment of the present disclosure.

Table 10 provides an output for an index lookup for the edge query of Table 5 in accordance with an embodiment of the present disclosure.

Table 11 provides a modified edge query with materialized and unmaterialized edges for the edge query of Table 5 in accordance with an embodiment of the present disclosure.

Table 12 provides another output for the edge query of Table 5 in accordance with an embodiment of the present disclosure.

Table 13 provides a final output for the edge query of Table 5 in accordance with an embodiment of the present disclosure.

Table 14 provides a cost of the skew strategy shown in Tables 5-8 in accordance with an embodiment of the present disclosure.

Table 15 provides a comparison of the cost in Tables 9 and 14 in accordance with an embodiment of the present disclosure.

Table 16 provides an edge query in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

A system obtains desired information from a database by dynamically adapting or modifying a query plan while executing a query against the database. In particular, the system accesses predefined cardinality information associated with the query for the database (such as a number of occurrences of information associated with the query in the database), and identifies query constraints based on the predefined cardinality information. Then, the system determines an initial query plan based on the query constraints. After executing an initial query against the database based on the initial query plan, the system revises the initial query and the initial query plan, based on partial results of the initial query, to produce a revised query and a revised query plan. Next, the system executes the revised query against the database based on the revised query plan to obtain additional partial results, and the system repeats the operations until a total result is obtained.

In this way, this querying technique may allow information associated with a query to be flexibly and efficiently extracted from the graph database. In particular, the system may dynamically adapt the query plan as more accurate information about skew in the database becomes available following execution of the initial query. This may allow the system to obtain the desired information in less time or in the minimum amount of time.

Consequently, the querying technique may reduce the computation time and the communication and memory requirements of a computer system to extract the desired information from the database for an application. Moreover, the querying technique may improve the performance of applications that use the graph database without changing the manner in which the applications access data in the graph database (i.e., by viewing data as a hierarchy of objects in memory with associated pointers). Furthermore, the improved performance of the applications may also improve the user experience when using the applications.

While the querying technique may be used with a wide variety of types of databases (including relational or hierarchical databases), in the discussion that follows a graph database is used as an illustrative example. Note that a graph database stores a graph that includes nodes, edges between the nodes, and predicates to represent and store data with index-free adjacency. Moreover, in this case, the query (which is sometimes referred to as an ‘edge query’) includes a subject, a predicate and an object, and the query may identify an edge associated with a predicate that specifies one or more of the nodes in the graph.

In the discussion that follows, an individual or a user may be a person (for example, an existing user of a social network or a new user of a social network). Also, or instead, the querying technique may be used by any type of organization, such as a business, which should be understood to include for-profit corporations, non-profit corporations, groups (or cohorts) of individuals, sole proprietorships, government agencies, partnerships, etc.

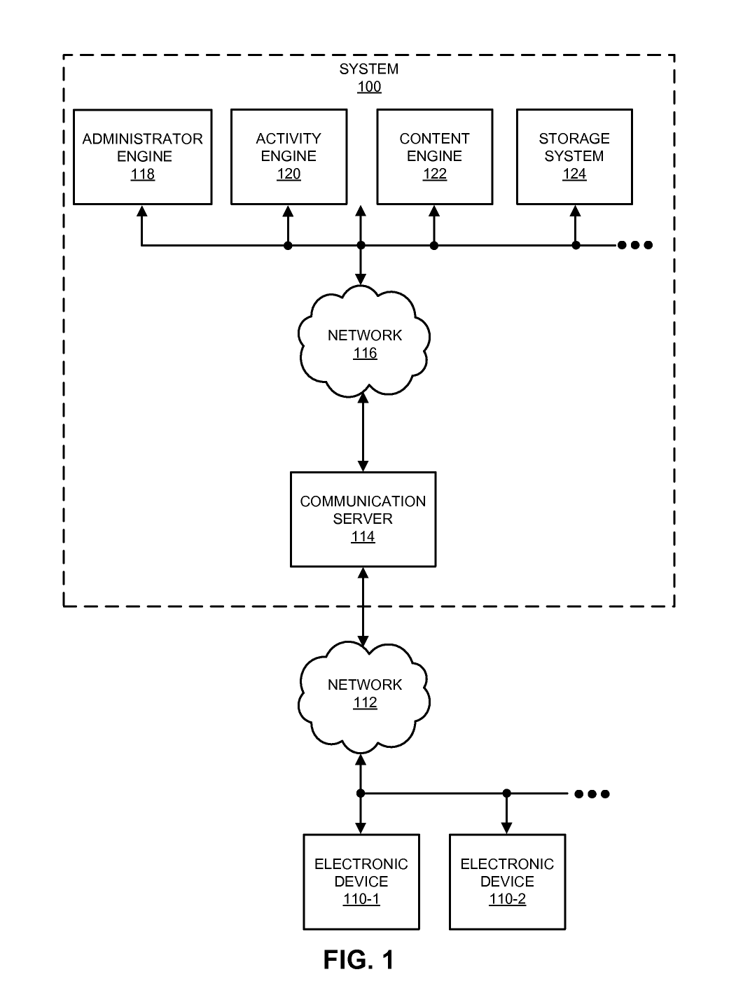

We now describe embodiments of the system and its use. FIG. 1 presents a block diagram illustrating a system 100 that performs a querying technique. In this system, users of electronic devices 110 may use a service that is provided, at least in part, using one or more software products or applications executing in system 100. As described further below, the applications may be executed by engines in system 100.

Moreover, the service may, at least in part, be provided using instances of a software application that is resident on and that executes on electronic devices 110. In some implementations, the users may interact with a web page that is provided by communication server 114 via network 112, and which is rendered by web browsers on electronic devices 110. For example, at least a portion of the software application executing on electronic devices 110 may be an application tool that is embedded in the web page, and that executes in a virtual environment of the web browsers. Thus, the application tool may be provided to the users via a client-server architecture.

The software application operated by the users may be a standalone application or a portion of another application that is resident on and that executes on electronic devices 110 (such as a software application that is provided by communication server 114 or that is installed on and that executes on electronic devices 110).

A wide variety of services may be provided using system 100. In the discussion that follows, a social network (and, more generally, a network of users), such as a professional social network, which facilitates interactions among the users, is used as an illustrative example. Moreover, using one of electronic devices 110 (such as electronic device 110-1) as an illustrative example, a user of an electronic device may use the software application and one or more of the applications executed by engines in system 100 to interact with other users in the social network. For example, administrator engine 118 may handle user accounts and user profiles, activity engine 120 may track and aggregate user behavior over time in the social network, content engine 122 may receive user-provided content (audio, video, text, graphics, multimedia content, verbal, written, and/or recorded information) and may provide documents (such as presentations, spreadsheets, word-processing documents, web pages, etc.) to users, and storage system 124 may maintain data structures in a computer-readable memory that may encompass multiple devices, i.e., a large-scale storage system.

Note that each of the users of the social network may have an associated user profile that includes personal and/or professional characteristics and experiences, which are sometimes collectively referred to as ‘attributes’ or ‘characteristics.’ For example, a user profile may include: demographic information (such as age and gender), geographic location, work industry for a current employer, an employment start date, an optional employment end date, a functional area (e.g., engineering, sales, consulting), seniority in an organization, employer size, education (such as schools attended and degrees earned), employment history (such as previous employers and the current employer), professional development, interest segments, groups that the user is affiliated with or that the user tracks or follows, a job title, additional professional attributes (such as skills), and/or inferred attributes (which may include or be based on user behaviors). Moreover, user behaviors may include: log-in frequencies, search frequencies, search topics, browsing certain web pages, locations (such as IP addresses) associated with the users, advertising or recommendations presented to the users, user responses to the advertising or recommendations, likes or shares exchanged by the users, interest segments for the likes or shares, and/or a history of user activities when using the social network. Furthermore, the interactions among the users may help define a social graph in which nodes correspond to the users and edges between the nodes correspond to the users' interactions, interrelationships, and/or connections. However, as described further below, the nodes in the graph stored in the graph database may correspond to additional or different information than the members of the social network (such as users, companies, etc.). For example, the nodes may correspond to attributes, properties or characteristics of the users.

Note that it may be difficult for the applications to store and retrieve data in existing databases in storage system 124 because the applications may not have access to the relational model associated with a particular relational database (which is sometimes referred to as an ‘object-relational impedance mismatch’). Moreover, if the applications treat a relational database or key-value store as a hierarchy of objects in memory with associated pointers, queries executed against the existing databases may not be performed in an optimal manner. For example, when an application requests data associated with a complicated relationship (which may involve two or more edges, and which is sometimes referred to as a ‘compound relationship’), a set of queries may be performed and the results may then be linked or joined. To illustrate this problem, rendering a web page for a blog may involve a first query for the three-most-recent blog posts, a second query for any associated comments, and a third query for information regarding the authors of the comments. Because the set of queries may be suboptimal, obtaining the results may, therefore, be time-consuming. This degraded performance may, in turn, degrade the user experience when using the application and/or the social network.

In order to address these problems, storage system 124 may include a graph database that stores a graph (e.g., as part of an information-storage-and-retrieval system or engine). Note that the graph may allow an arbitrarily accurate data model to be obtained for data that involves fast joining (such as for a complicated relationship with skew or large ‘fan-out’ in storage system 124), which approximates the speed of a pointer to a memory location (and thus may be well-suited to the approach used by applications).

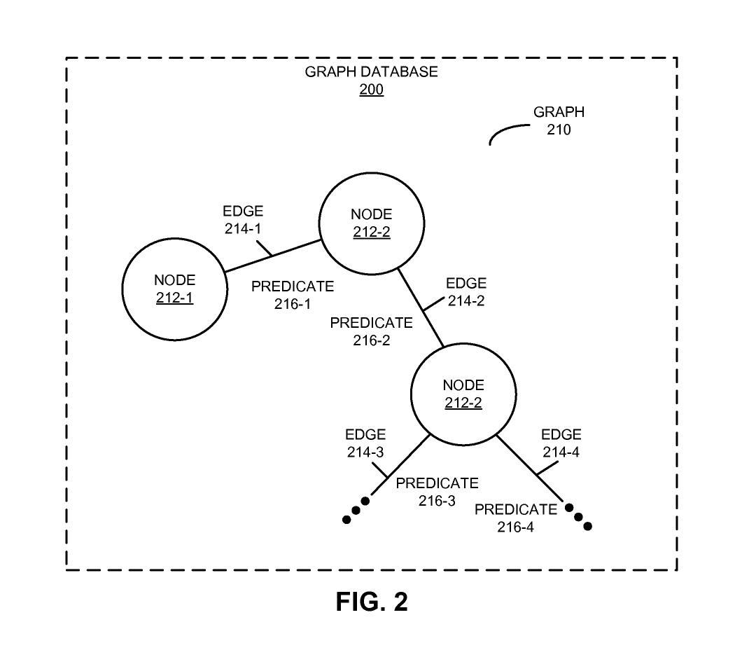

FIG. 2 presents a block diagram illustrating a graph 210 stored in a graph database 200 in system 100 (FIG. 1). Graph 210 may include nodes 212, edges 214 between nodes 212, and predicates 216 (which are primary keys that specify or label edges 214) to represent and store the data with index-free adjacency, i.e., so that each node 212 in graph 210 includes a direct edge to its adjacent nodes without using an index lookup.

Note that graph database 200 may be an implementation of a relational model with constant-time navigation, i.e., independent of the size N, as opposed to varying as log(N). Moreover, all the relationships in graph database 200 may be first class (i.e., equal). In contrast, in a relational database, rows in a table may be first class, but a relationship that involves joining tables may be second class. Furthermore, a schema change in graph database 200 (such as the equivalent to adding or deleting a column in a relational database) may be performed with constant time (in a relational database, changing the schema can be problematic because it is often embedded in associated applications). Additionally, for graph database 200, the result of a query may be a subset of graph 210 that preserves intact the structure (i.e., nodes, edges) of the subset of graph 210.

The querying technique may include embodiments of methods that allow the data associated with the applications and/or the social network to be efficiently stored and retrieved from graph database 200. For example, the querying technique may provide a subset of graph 210 in response to a query that is either received by system 100 (FIG. 1) and/or generated by system 100 (FIG. 1). Moreover, the results of a query may be used in concatenated or sequential queries. In particular, instead of independently applying a first query and a second query to graph database 200, the second query may be applied to the results of the first query (which include a subset of graph 210). In this way, complicated relationships can be obtained directly without subsequent joining or linking of intermediate results, thereby reducing the time needed to obtain desired information and the system resources used to obtain the desired information.

In some embodiments, a query that is associated with another type of database or that is in a different language than that associated with graph database 200 (such as JavaScript Object Notation or JSON) may be translated into the edge-based format that is used with graph database 200 prior to executing the query against graph database 200.

Moreover, in some embodiments graph database 200 is subdivided into ‘shards’ on multiple computers or storage nodes that contain subsets of the data. This approach may allow distributed query processing without performing multiple queries on each of multiple shards in graph database 200, and/or maintaining distributed information about the structure of graph database 200 in the shards (such as a global index that specifies the location in graph database 200 where particular data is stored).

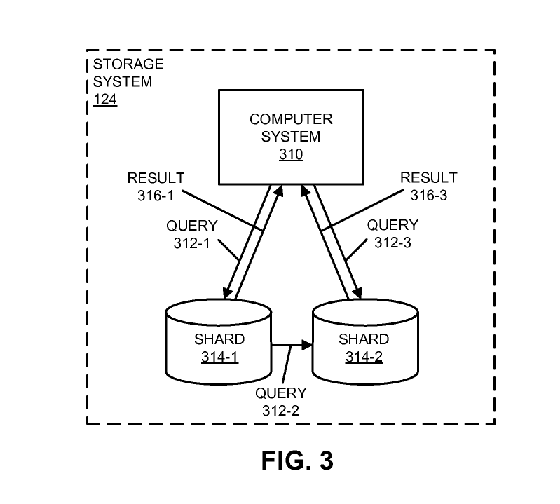

In particular, as shown in FIG. 3, which presents a block diagram illustrating communication within graph database 200 (FIG. 2), a computer system 310 (such as a server) in storage system 124 executes a query associated with an application (such as a query received from the application and/or generated by storage system 124) by providing a query message 312-1 including the query and a first query header to a shard 314-1 (e.g., another computer system, a component of a distributed storage system, etc.) of graph database 200 (FIG. 2). Note that the first query header may specify shard 314-1.

In response to the query, computer system 310 may receive a result message 316-1 with first results and a first result header from shard 314-1, where the first result header specifies that the first results are first partial results that are a fraction of a total result. Moreover, computer system 310 may receive result message 316-3 with second results and a second result header from shard 314-2, where the second result header specifies that the second results are second partial results that are a second fraction of a total result. Note that a combination of the first partial results and the second partial results (and possibly additional results) may provide the total result to the query. The total result may include a subset of the graph, which includes desired information expressed within an associated structure of the graph in graph database 200 (FIG. 2). Thus, computer system 310 may combine the first partial results and the second partial results (and additional results, as necessary) to obtain the total result.

Furthermore, computer system 310 may receive result message 316-3 without directly communicating a query message to shard 314-2. Instead, shard 314-1 may provide, to shard 314-2, query message 312-2 with the query and a second query header (which specifies shard 314-2). Alternatively, computer system 310 may receive result message 316-3 after directly communicating query message 312-3 to shard 314-2. Thus, the communication protocol in the querying technique may involve direct (1:1) communication between a given shard and computer system 310 (such as when the location of the desired information in shards 314 is known), direct (N:1) communication between shards 314 and computer system 310 and/or indirect communication between one or more of shards 314 and computer system 310 mediated by one or more intervening shards (i.e., when messages are forwarded from one shard to another).

In some embodiments, computer system 310 may maintain a request map that keeps track of outstanding queries and where they were sent (e.g., which of shards 314), so that, if computer system 310 determines that a portion of the total result is missing or a predefined time interval (such as a timeout) has elapsed, computer system 310 can resend the query to the appropriate shard or shards. For example, the predefined time interval may be 1, 5, or 10 s.

Referring back to FIG. 1, system 100 dynamically modifies a query plan while executing a query against a graph database in storage system 124 to address skew in the graph database. In particular, storage system 124 may receive a query from an application executed by system 100 or may generate the query. Then, storage system 124 may access predefined cardinality information associated with the query, and may identify query constraints (such as a constraint graph) based on the predefined cardinality information. For example, the graph database may provide constant-time access to the predefined cardinality information, and the predefined cardinality information may include a number of nodes, edges and predicates in the graph that are associated with a subject, a predicate, and/or an object. Moreover, storage system 124 may determine an initial query plan based on the query constraints.

Next, storage system 124 may execute an initial query against the database based on the initial query plan. Furthermore, storage system 124 may revise the initial query and the initial query plan, based on partial results of the initial query, to produce a revised query and a revised query plan. Additionally, storage system 124 may execute the revised query against the database based on the revised query plan to obtain additional partial results. Storage system 124 may further revise the revised query and the revised query plan, and may further execute the revised query, until a total result for the query is obtained, thereby iteratively and adaptively addressing skew in the graph database.

Note that the query may be a declarative query so that it expresses computational logic without expressing an associated control flow, which allows storage system 124 to determine and dynamically adapt the query plan (e.g., based on the cost or processing time). Moreover, the initial query plan and/or the revised query plan may include a hash join or an index join.

Referring again to FIG. 3, in embodiments where the graph database is subdivided into multiple shards 314, storage system 124 (FIG. 1) may split the query into subqueries, and may provide the subqueries to shards 314, where a given shard receives at least a given subquery. Moreover, each of shards 314 may independently perform the operations of determining the initial query plan, executing the initial query, revising the initial query, and executing the revised query. Thus, one or more of shards 314 may dynamically determine a different query plan than one or more other shards 314.

Referring back to FIG. 1, in this way the querying technique may allow desired information associated with query to be flexibly and efficiently (e.g., optimally) extracted from the graph database. In particular, the querying technique a query plan can be dynamically adapted while a query is executed against the graph database, thereby reducing or minimizing the time needed to obtain the desired information, even in the presence of significant skew in the graph database.

Consequently, querying techniques described herein may reduce the computation time and the communication and memory requirements needed for system 100 to extract the desired information from the graph database for an application. Moreover, the querying techniques may improve the availability and the performance or functioning of the applications, the social network and system 100, which may reduce user frustration and which may improve the user experience. Therefore, the querying techniques may increase engagement with or use of the social network, and thus may increase the revenue of a provider of the social network.

Note that information in system 100 may be stored at one or more locations (i.e., locally and/or remotely). Moreover, because this data may be sensitive in nature, it may be encrypted. For example, stored data and/or data communicated via networks 112 and/or 116 may be encrypted.

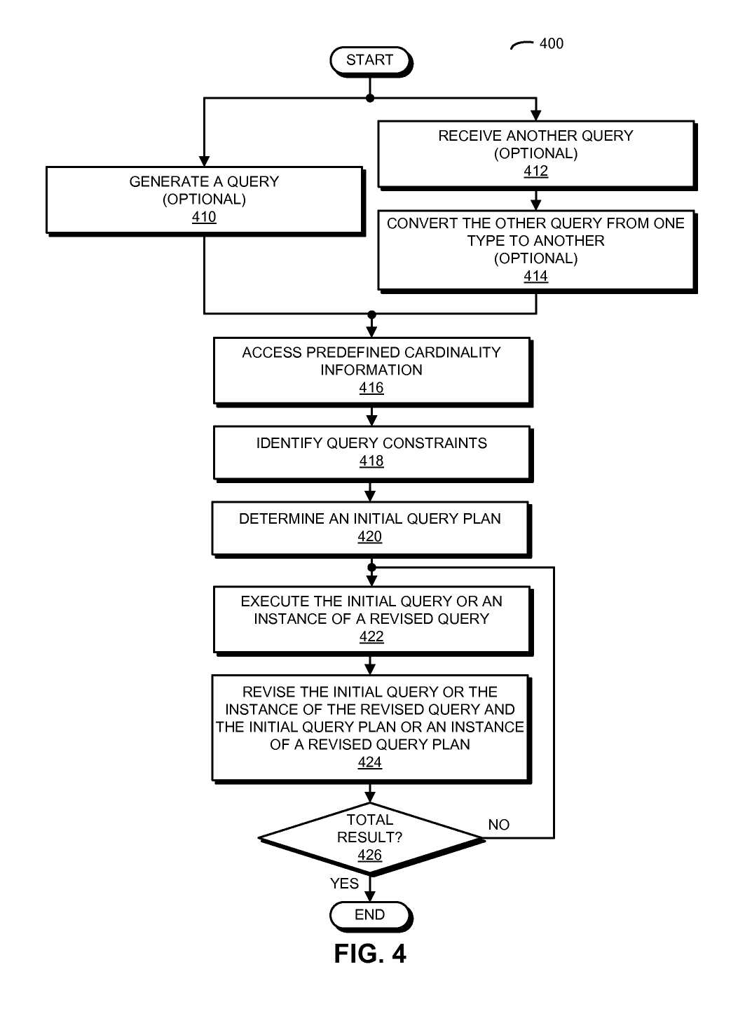

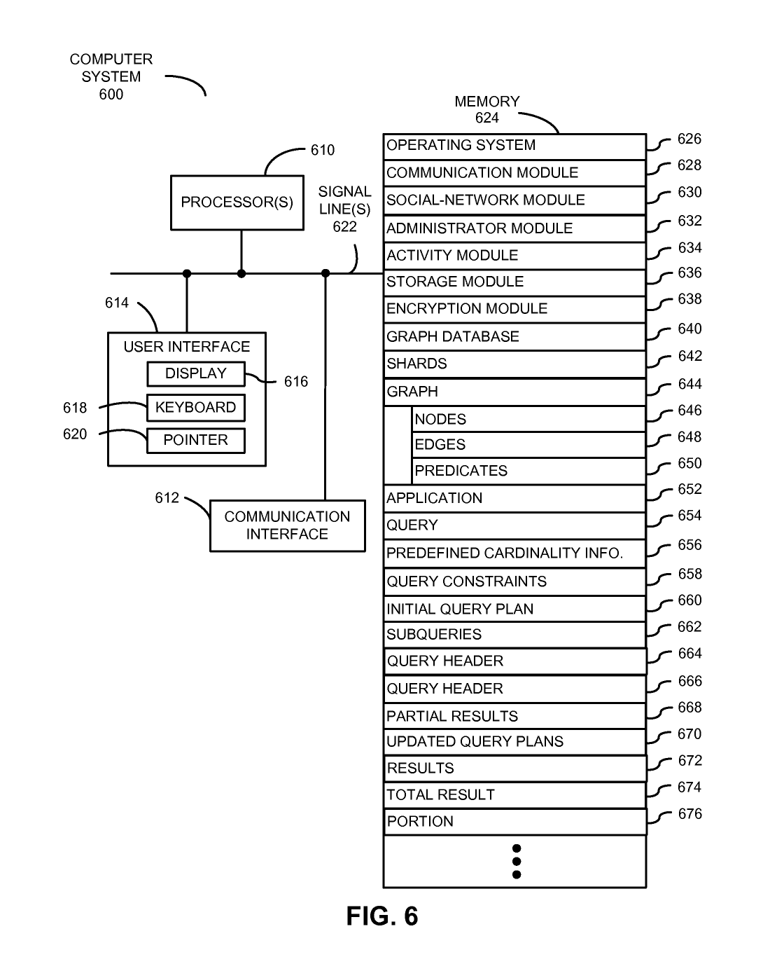

We now describe embodiments of the querying technique. FIG. 4 presents a flow chart illustrating a method 400 for requesting desired information from a graph database, which may be performed by a computer system (such as system 100 in FIG. 1 or computer system 600 in FIG. 6). During operation, the computer system may optionally generate a query (operation 410). For example, the query may include a subject, a predicate and an object based on desired information (which may have been received from an application).

Alternatively, the computer system may optionally receive another query (operation 412), from the application for example, and the computer system may optionally convert the other query from one type to another (operation 414). For example, the other query may be compatible with a type of database that is different from the graph database (such as a relational database and/or a hierarchical database, e.g., the type of database may use SQL). In some embodiments, the other query is compatible with JSON, and may be converted into a query compatible with Datalog. More generally, the query obtained via operation 410 or operation 414 may be compatible with a query language that is declarative so that it expresses computational logic without expressing an associated control flow (i.e., it may indicate to the computer system a desired outcome without specifying how it should be achieved, so that it can be optimized), and may be complete so that an arbitrary computation is represented or expressed by the query language (e.g., the query language may have features such as transformation, composition, and query by example).

Then, the computer system may access predefined cardinality information (operation 416) associated with the query, and the computer system may identify query constraints (operation 418) based on the predefined cardinality information. For example, the graph database may provide constant-time access to the predefined cardinality information, and the predefined cardinality information may include a number of nodes, edges and predicates in the graph that are associated with a subject, a predicate, and/or an object. Moreover, the computer system may determine an initial query plan (operation 420) based on the query constraints.

Next, the computer system may execute an initial query (operation 422) against the database based on the initial query plan. Furthermore, the computer system may revise the initial query and the initial query plan (operation 424), based on partial results of the initial query, to produce an instance of a revised query and an instance of a revised query plan. Additionally, the computer system may iteratively execute an instance of the revised query (operation 422) against the database based on an instance of the revised query plan to obtain additional partial results, and the computer system may further revise the instance of the revised query and the instance of the revised query plan (operation 424) until a total result for the query is obtained (operation 426), thereby iteratively and adaptively addressing skew in the graph database.

Note that the initial query plan and/or an instance of the revised query plan may include a hash join or an index join.

In some embodiments, when the graph database is subdivided into or includes multiple shards, the computer system splits the query into subqueries, and provides the subqueries to the shards, where a given shard receives at least a given subquery, but one or more shards may not receive any subquery. Moreover, each of the shards may independently perform the operations of determining the initial query plan (operation 420), executing the initial query (operation 422), revising the initial query (operation 424), and repeating these operations with instances of the revised query and the revised query plan until the total result is obtained (operation 426).

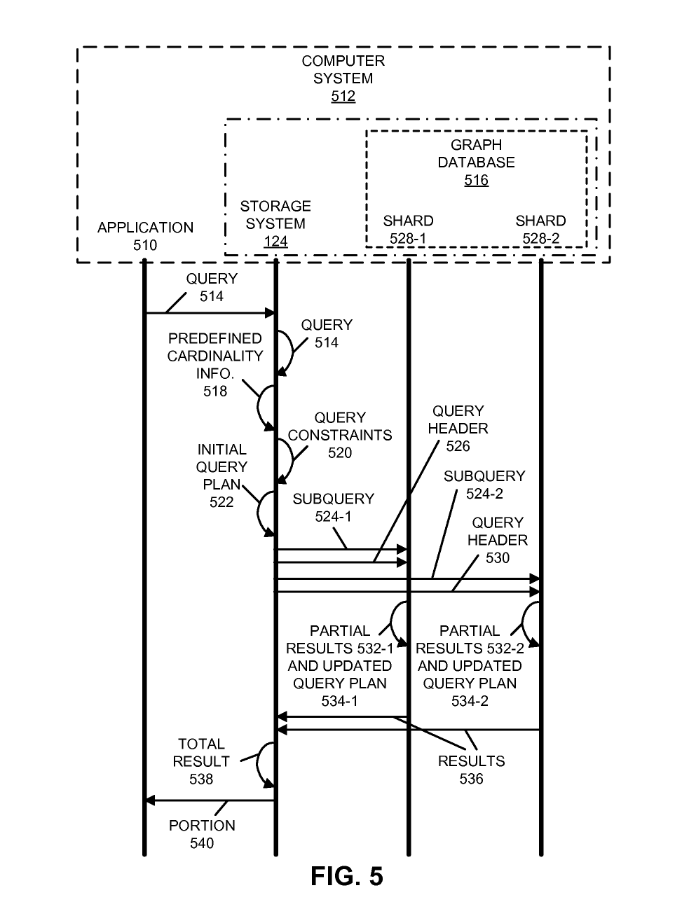

In an exemplary embodiment, method 400 is implemented using one or more applications and a storage system (or engine), in the computer system, that interact with each other. This is illustrated in FIG. 5. During this method, an application 510 executing in computer system 512 (which may implement some or all of the functionality of system 100 in FIG. 1) may provide a query 514 to storage system 124. Alternatively, storage system 124 may generate query 514 (e.g., based on desired information requested by application 510) or may translate an initial query received from application 510 (which may be in a different language that is not compatible with graph database 516) into query 514 (which is an edge query that is compatible with graph database 516).

Then, storage system 124 may access predefined cardinality information 518 associated with query 514, and may identify query constraints 520 based on predefined cardinality information 518. Moreover, storage system 124 may determine an initial query plan 522 based on query constraints 520.

Next, storage system 124 may execute query 514 against graph database 516, which stores a graph, by providing at least subquery 524-1 and a query header 526 to a shard 528-1 of graph database 516. In some embodiments, storage system 124 optionally provides subquery 524-2 and a query header 530 to a shard 528-2 of graph database 516.

When executing subqueries 524, each of shards 528 independently and iteratively obtains intermediate or partial results 532, and determines one of updated query plans 534 until all results 536 for subqueries 524 are obtained. Then, shards 528 may return results 536 to storage system 124, which may optionally combine results 536 to obtain total result 538 for query 514. Note that desired information may be expressed in total result 538 within an associated structure of the graph. In some embodiments, storage system 124 optionally provides at least a portion 540 of total result 538 to application 510.

In an exemplary embodiment, the graph database has a schema that represents edges using triples (subject, predicate, object) that specify first-class relations. The use of a triple as the fundamental relation in the data provides meaning that can be directly consumed by a human being. In some embodiments, a quad is used to capture/represent additional information, such as ownership or provenance. However, in other embodiments a variable length relation is used in the graph.

Note that each field in a triple may have an associated integer ‘entity identifier.’ This edge structure may allow joining to occur in the domain of integers, specifically sets of integers as marshalled by an inverted index. Moreover, this domain may allow succinct representation and a fast join implementation. Furthermore, the triples may be mapped into structure hierarchies, such as JSON or HyperText Markup Language (HTML) templates that are often used in the upper reaches of the stack. Thus, query results may be converted in JSON.

In the graph database, there may not be a separate notion of an ‘attribute.’ Instead, two different edge types may be represented by two different triples having a common intermediate node. For example, a member-to-member connection between members 1234 and 4567 in the social network may be represented as Edge(x, ‘left_member’, ‘member/1234’), Edge(x, ‘left_score’, 6.7), Edge(x, ‘right_member’, ‘member/4567’), Edge(x, ‘right_score’, 23.78) and Edge(x, ‘creation_date’, ‘2014-sep-26’), where ‘x’ indicates the intermediate node. Note that data formerly known as ‘attributes’ may exist as triples that are separately updatable, fully indexed, and queryable without additional complexity. As with other predicates, predicates used as attributes may be created on demand.

The physical storage for the graph and the indexes may be log structured and may be mapped directly to memory. Nodes and edges may be identified by their offset in the physical log. This log structure may create a natural virtual time that can be exploited for consistency, and that may allow unrestricted parallel access to physical data and indexes for join performance.

As noted previously, edges may be accessible by inverted indexes. For example, ‘iSub(1234)’ may yield a set of integer node identifiers and log offsets of the edge(s) whose subject is ‘1234.’ Inverted indexes with pre-computed subject-predicate and object-predicate intersections may allow constant-time navigation, which consists of a hash-table lookup to get a set of edges followed by an array access to navigate across each edge.

Note that the inverted indexes may be ‘normalized’ in the sense that they may not include copies of any of the data that they index. Thus, the schema for an inverted index may include a mapping from a subject identifier to a set of edge identifiers (S→{I}), a mapping from a predicate identifier to a set of edge identifiers (P→{I}), a mapping from an object identifier to a set of edge identifiers (O→{I}), a mapping from a subject identifier and a predicate identifier to a set of edge identifiers (S,P→{I}), and a mapping from an object identifier and a predicate identifier to a set of edge identifiers (O,P→{I}). Moreover, the set of edge identifiers may in turn specify the triple (I[i]→{S:s, P:p, O:o}).

Furthermore, using a 3-level memory hierarchy, de-normalization (i.e., copying parts of the edge into the indexes) can result in faster execution and a smaller memory footprint (S→{P,O}, P→{S,O}, O→{P,S}, S,P→{O} and O,P→{S}). This approach may be equivalent to a posting list. Note that the index may not need to include the edges at all. In some embodiments, this approach may be extended further so that S→P→{O},P→S→{O},P→O→{S} and O→P→{S}. Thus, there may be two predicate indexes, one forward from S to O and another in reverse. In principle, all six permutations may be needed, but in practice for most queries four may be sufficient.

In some embodiments of de-normalization, graphs are created for some or all entities in the social network (individual members, companies, etc.). In this example, a graph may include a complete neighborhood of first-order connections, with tens or even hundreds of thousands of edges. While this approach would duplicate a huge amount of data, there may not be a need for indexing. Instead, a single sequential scan of the edges may be stored in memory.

In an exemplary embodiment, an initial query from an application for data for a blog is in JSON. This is shown in Table 1, which shows a JSON query for blog posts sorted in descending order, by date. As shown in Table 2, an initial query may be translated to or expressed as an edge query that is compatible with a graph database (such as an edge query expressed using Datalog or Prolog). In this edge query, keys from the initial query become predicates, such as ‘text,’ ‘comments,’ and ‘author.’ Moreover, the edge query may include a string (such as ‘comment’) and/or a variable (such as ‘P’ or ‘C’). For example, the edge query may include syntax that specifies the date, order by date, a limit of three blog posts, etc. In Table 2, note that things to the left of are known as or are referred to as rules. In the edge-query format, multiple definitions of the same rule are disjunctions (ORs), and things separated by commas are conjunctions (ANDs).

TABLE 1

```
[{“node identifier” : “post 25”
  “text”: “This is my blog ...”
  “comments”: [{
```

“author”:{

“name”: “Joe”
“image”: “http// ...”
...
}

“text”: “I agree”

TABLE 2

q(...) :-

Edge(P, “comment”, C)
Edge(C, “author”, _ )
Edge(C, “text”, _ )
...

Table 3 shows results for an edge query, which include a group of edges in a subset of a graph, each of which is specified by a subject, a predicate and an object. Note that, in general, an edge query is a set of constraints that are to be applied to a database, and the output or result is a portion or a subset of a graph that meets the constraints (without hierarchical or relational constraints). Because the result includes the portion of the graph (with its associated structure), the result can be used without a schema or knowledge of the relational model implemented in the graph database. For example, the query can be applied to the result (i.e., the output of the query), and the same result may be obtained. Such a conjunctive query is typically not possible with an SQL query for a relational database.

TABLE 3

Edge(“post 25”, “text”, “This is my blog ...”)
Edge(“post 25”, “comments”, “C1”)
Edge(“C1”, “author”, “Joe”)
...

In some embodiments, a graph may be larger than a single machine (or computer system) can store intact, so it may be split up into shards with a machine dedicated to each shard. In some embodiments, a hybrid sharding approach is used, in which a large index set is split across many machines to allow parallelism, while at the same time keeping small index sets together on a single machine so that query evaluation can make decisions based on a ‘locally closed world.’ For example, such a graph partitioning may have the entertainment industry in one shard, computer programmers in another, finance in another, and so forth. Thus, for an influential member of a professional social network, such as Bob Ridley, millions of follower edges may be spread across multiple shards.

By specifying that each shard is a database in its own right, and making an initial top-level query evaluator work with a federation of databases, flexibility in the sharding implementation may be obtained. In particular, federated query evaluation may start by offering the complete query to all shards with the expectation that each shard will return everything it knows about the result or the answer. Thus, responses may range from the complete answer to a set of member-to-member links in the social network that may play a role in the result.

In embodiments of a database with multiple shards, an incoming message directed to a graph database, such as a query, may include a message header. The message header may include: a unique message identifier; a sub-message identifier that, when combined with the message identifier, can identify a unique part of a message (or a query) in one-to-many communication with particular shards; resources (such as a timestamp, processor, memory, etc.); a sequence identifier that specifies the order of a set of packets associated with a given message (which may be useful because the communication within the graph database may be asynchronous); a source node where the initial message came from; and a node uniform resource locator that tells a recipient where a message was sent from. Note that, by using the sequence identifier and an end-of-message character, a storage system may determine whether all of the packets in the set of packets have been received (i.e., a stream has ended) or the order of the packets in the set of packets. For example, the sequence identifier of packets in the set of packets may start with ‘0’ and may increase monotonically until a last packet, which may include the end-of-message character (or the end-of-message character may be true instead of false). Thus, the sequence identifier of a packet that includes the end-of-message character may be the maximum value of the sequence identifier.

Moreover, an outgoing message issued by a graph database or a portion (e.g., a shard) of a graph database, such as a result of a query, may include: a unique message identifier; a sub-message identifier that, when combined with the message identifier, can identify a unique part of a message (or a query) in one-to-many communication with particular shards; resources (such as a timestamp, processor, memory, etc.); a sequence identifier that specifies the order of a set of packets associated with a given message; a source node where the initial message came from; an error-message string that specifies any errors that occurred; a node uniform resource locator that tells a recipient where a message was sent from; the end-of-message character that indicates whether this is the last packet or whether the data is complete (if not, additional packets will be received with the same message identifier and the same sub-message identifier); and status information (such as success, error, not available, cancel or continue, when a query is forwarded to another shard). Note that, by using the sequence identifier and the end-of-message character, a storage system may determine whether all of the packets in the set of packets have been received or the order of the packets in the set of packets. For example, if the sequence identifier is five, when six packets are received the storage system knows that all the data has been received.

Furthermore, the message headers may include information that indicates that a query has been split or subdivided when a given shard obtained a partial result and forwarded the query to another shard (i.e., when there is fanout of a message). In particular, the message headers may include a weight (which is sometimes referred to as a ‘refcnt’). The refcnt may include 64 bits and may start with a maximum value of one. Each time a query or a message is split, the refcnt may be split evenly among the children (divide by N). Thus, an initial message refcnt may become ½ and then ⅓.

When the storage system receives a response, it may start totaling up the weight or the refcnts, such that when a total weight or refcnt of one is received or determined, the storage system knows it is done. For example, if a refcnt of 0.5 is received, the storage system knows to wait for the remaining 0.5 in one or more other messages.

Note that if a portion of the total result is missing, the total refcnt is less than a maximum value, or a timeout since a query was provided has been exceeded, the storage system may resend a query. For example, if a sequence identifier of a portion of a set of packets is missing, the storage system may know where it was supposed to come from, i.e., a particular shard, and the storage system may resend a query to that shard.

This communication protocol for use with databases with multiple shards may provide a way to manage queries and subqueries, as well as to handle message fanout within a graph database. In particular, the communication protocol may allow the shards to ‘fire and forget’ when processing queries in a graph database. Instead, as noted previously, a computer system in the storage system may optionally keep track of outstanding queries and where they were sent using a request map.

As noted previously, database skew can result in significant differences in execution time for queries or, depending on a query plan (i.e., how a given query is executed at runtime), for the given query. In the case of a graph database, a given predicate, <subject, predicate> or <predicate, object> pair can return results of vastly different size. For example, for the “followed by” predicate, a query of Edge(“Bob Ridley”, “followed by”, _)? may have more than 8 M results, while a query of Edge(“John Smith”, “followed by”, _)? may have a few thousand results. In this example, the predicate “followed by” is highly skewed on subject, as the number of edges for a <subject, “followed by”> pair can return a result varying in size from zero to 8 M.

However, the same predicate is not skewed (or is not as skewed) on object, as (_, “followed by”, “Bill James”) or any <predicate, object> pair may return a result varying in size from zero to 30 k. While this distribution is not uniform, given the range it may not be classified as skewed.

Another example is the predicate “lives in.” This predicate may be skewed on object, because the number of edges for a <“lives in”, object> pair can return a result of varying in size from 100 to 8 M. For example, a query Edge(_, “lives in”, “New York City”)? may have 8 M results, a query Edge(_, “lives in”, “Madison, Wis.”)? may have 250 k results, and Edge(_, “lives in”, “Vernon, California”)? may have 100 results.

Skew may affect data storage and query execution. In the discussion that follows, we focus on the effects on query execution.

Because of skew, one query evaluation strategy or query plan may not work on skewed and non-skewed data. For example, consider a query for the followers of company A employees in “New York City” or “Vernon, Calif.,” and assume that there are only two employees of company A, Bob Ridley and John Smith. In one simplified query plan, we may first find the followers of Bob Ridley or John Smith, and then we may check whether they live in New York City or Vernon, Calif. This approach may work for the followers of John Smith, but may not work for Bob Ridley.

Alternatively, we can find people living in Vernon, Calif., and New York City and, for each user, we can check whether they follow Bob Ridley or John Smith. This approach may work for the residents of Vernon, Calif., but may not work for the residents of New York City.

Because of skew, an approach that works for some edges may not work for the skewed case. Consequently, if an optimizer in the storage system initially picks the first approach or query plan or the second, it may need to detect the skew and proceed with unskewed edges using the current approach, and delay execution of skewed edges. In embodiments that employ a greedy strategy in the optimizer, because of the delayed execution of other constraints, there may be more bindings on the skewed edges that results in a less costly execution or query plan.

Based on the preceding discussion, instead of using one approach (which may be insufficient for evaluating a constraint entirely), in the querying technique part of the constraint may be evaluated using one approach and the other part of the constraint may be delayed in the hope of a smaller cost because of the execution of other constraints. In particular, during constraint evaluation (i.e., at the time of execution, instead of during constraint complication), when skew is discovered, then the evaluation of a constraint may be split into multiple constraints.

In some embodiments, the graph database (or databases) uses a static query plan, which is determined or specified prior to executing a query against the graph database. In these embodiments, the optimizer may inspect a query and, with the help of statistics from the data and indexes (such as predefined cardinality information), produce a query plan that is then executed. This static approach may work well when the overhead of starting or stopping execution is large (such as when data is streaming from a hard disk drive) and the data may be readily summarized using statistics.

However, because graph data stored in memory typically does not have these properties (it is usually never more than an L3 cache-miss from a processor, and skew is common), in some embodiments the graph database (or databases) uses dynamic query optimization. As shown in Table 4, a three-hop path ‘a.b.c’ may be embedded in a larger query q. Based on the indexes, the number of edges with predicates a, b, and c can be determined. Suppose that those are 400, 10 M, and 200 k edges, respectively. The evaluation may start with a. This may identify a set of candidates for x1 and x2, and these sets may be no larger than the number of edges, say 400 and 300, respectively. If there are 300 x2s, it may be reasonable to proceed with the b edges even though there are 10 M of those. For example, if b is ‘place of birth,’ there may be at most 300 candidates for x3. However, if b is something like ‘follows,’ then x2[0] may have 20 edges, x2[1] may have 243 edges, and x2[2] may have 5 M. With a static query plan, there would be no choice other than grinding through all 5 M possibilities. Alternatively, a dynamic evaluator may defer processing the large fan-out as long as it remained more expensive than other alternatives, by either evaluating c or some other constraint in the ellipsis which might remove x2[2] from consideration.

TABLE 4

q(...) :-

...
Edge(x1, ‘a’, x2),
Edge(x2, ‘b’, x3),
Edge(x3, ‘c’, x4),
...

Another example of a query, or an edge query, and associated predefined cardinality or count information is shown in Table 5. One possible execution strategy is an index lookup join without any special skew handling. In particular, first join Edge 0 and Edge 1 using a first index lookup (Edge 0 is outer and Edge 1 is inner). The output of this first index lookup is shown in Table 6. Then, join Edge 1 and Edge 2 using a second index lookup (Edge 2 is outer and Edge 1 is inner). The output of this second index lookup is shown in Table 7. Note that the output in Table 7 includes the result for one row of Edge 2. For the other four edges of Edge 2 (for values b2, b3, b4 and b5), similar result sets occur. Finally, after the second index lookup, the unmaterialized edges for Edge 1 may be materialized. The final output is shown in Table 8. Moreover, the cost for this non-skew strategy is summarized in Table 9.

TABLE 5

| | |
|---|---|
| P(a,b) :- Edge(a, “x”, h1), % Edge 0 | Predefined Cardinality (or Count) |
| Edge(h1,“y”, h2), % Edge 1 | Information: |
| Edge(h2, “z”, b), % Edge 2 | Edge(_, “x”, _)? −> 5 rows |
| | Edge(_, “y”, _)? −> 10M rows |
| | Edge(_, “z”, _)? −> 5 rows |

TABLE 6

| Materialized edges for Edge 0 | | | Unmaterialized edges for Edge 1 | | |
|---|---|---|---|---|---|
| a1 | “x” | h1_1 | h1_1 | “y” | count = 2 |
| a2 | “x” | h1_2 | h1_2 | “y” | count = 2 |
| a3 | “x” | h1_3 | h1_3 | “y” | count = 2 |
| a4 | “x” | h1_4 | h1_4 | “y” | count = 2 |
| a5 | “x” | h1_5 | h1_5 | “y” | count = 1M |

TABLE 7

| Materialized edges | | | Unmaterialized edges | | | | Materialized edges | | |
|---|---|---|---|---|---|---|---|---|---|
| for Edge 0 | | | for Edge 1 | | | | for Edge 2 | | |
| a1 | “x” | h1_1 | h1_1 | “y” | h2_1 | count = 0 | h2_1 | “z” | b1 |
| a2 | “x” | h1_2 | h1_2 | “y” | h2_1 | count = 1 | h2_1 | “z” | b1 |
| a3 | “x” | h1_3 | h1_3 | “y” | h2_1 | count = 0 | h2_1 | “z” | b1 |
| a4 | “x” | h1_4 | h1_4 | “y” | h2_1 | count = 0 | h2_1 | “z” | b1 |
| a5 | “x” | h1_5 | h1_5 | “y” | h2_1 | count = 1 | h2_1 | “z” | b1 |

| | | |
|---|---|---|
| Other edges not | Other edges not | Other edges not |
| shown | shown | shown |

TABLE 8

| Materialized edges | | | Unmaterialized edges | | | Materialized edges | | |
|---|---|---|---|---|---|---|---|---|
| for Edge 0 | | | for Edge 1 | | | for Edge 2 | | |
| a1 | “x” | h1_1 | h1_1 | “y” | h2_2 | h2_2 | “z” | b2 |
| a2 | “x” | h1_2 | h1_2 | “y” | h2_2 | h2_2 | “z” | b2 |
| a3 | “x” | h1_3 | h1_3 | “y” | h2_4 | h2_4 | “z” | b4 |
| a4 | “x” | h1_4 | h1_4 | “y” | h2_5 | h2_5 | “z” | b5 |
| a5 | “x” | h1_5 | h1_5 | “y” | h2_5 | h2_5 | “z” | b5 |

TABLE 9

| | | Number of edges |
|---|---|---|
| Operation | Lookups | materialized |
| 1 | 1 (for outer part of join) | 5 |
| 2 | 1 (for outer part of join) | 5 |
| 3 | 25 (for unmaterialized edge set) | 5 |
| Total | 27 | 15 |

Alternatively, an execution strategy with special skew handling may be used. First, join Edge 0 and Edge 1 using a first index lookup (Edge 0 is outer and Edge 1 is inner). The output of this first index lookup is shown in Table 10. At this point, using the estimated predefined cardinality information or count from the index (or a lookup table), the skew can be detected and a row containing h1_5 may be identified as one that should be handled specially for skew. Consequently, as part of skew, a separate edge may be created for this row, as shown in Table 11.

TABLE 10

| Materialized edges for Edge 0 | | | Unmaterialized edges for Edge 1 | | |
|---|---|---|---|---|---|
| a1 | “x” | h1_1 | h1_1 | “y” | count = 2 |
| a2 | “x” | h1_2 | h1_2 | “y” | count = 2 |
| a3 | “x” | h1_3 | h1_3 | “y” | count = 2 |
| a4 | “x” | h1_4 | h1_4 | “y” | count = 2 |
| a5 | “x” | h1_5 | h1_5 | “y” | count = 1M |

TABLE 11

| | Materialized edges for Edge 0 | | | Unmaterialized edges for Edge 1 | | |
|---|---|---|---|---|---|---|
| Not | a1 | “x” | h1_1 | h1_1 | “y” | count = 2 |
| skewed | a2 | “x” | h1_2 | h1_2 | “y” | count = 2 |
| | a3 | “x” | h1_3 | h1_3 | “y” | count = 2 |
| | a4 | “x” | h1_4 | h1_4 | “y” | count = 2 |
| Skewed | a5 | “x” | h1_5 | h1_5 | “y” | count = 1M |

Then, non-skewed Edge 2 may be joined with Edge 3 using a hash join and Edge 2 and Edge 3 may be joined using an index lookup (with Edge 3 as outer), as shown in Table 12. Next, the unmaterialized edges for Edge 1 in the skewed portion of the result set may be materialized. The final output is shown in Table 13.

TABLE 12

| | Materialized edges for Edge 0 | | | Unmaterialized edges for Edge 1 | | | Materialized edges for Edge 2 | | |
|---|---|---|---|---|---|---|---|---|---|
| Not skewed | a1 | “x” | h1_1 | h1_1 | “y” | h2_2 | h2_2 | “z” | b2 |
| | a2 | “x” | h1_2 | h1_2 | “y” | h2_2 | h2_2 | “z” | b2 |
| | a3 | “x” | h1_3 | h1_3 | “y” | h2_4 | h2_4 | “z” | b4 |
| | a4 | “x” | h1_4 | h1_4 | “y” | h2_5 | h2_5 | “z” | b5 |
| Skewed | a5 | “x” | h1_5 | h1_5 | “y” | h2_1 | h2_1 | “z” | b1 |
| | a5 | “x” | h1_5 | h1_5 | “y” | h2_2 | h2_2 | “z” | b2 |
| | a5 | “x” | h1_5 | h1_5 | “y” | h2_3 | h2_3 | “z” | b3 |
| | a5 | “x” | h1_5 | h1_5 | “y” | h2_4 | h2_4 | “z” | b4 |
| | a5 | “x” | h1_5 | h1_5 | “y” | h2_5 | h2_5 | “z” | b5 |

TABLE 13

| | Materialized edges for Edge 0 | | | Unmaterialized edges for Edge 1 | | | Materialized edges for Edge 2 | | |
|---|---|---|---|---|---|---|---|---|---|
| Not skewed | a1 | “x” | h1_1 | h1_1 | “y” | h2_2 | h2_2 | “z” | b2 |
| | a2 | “x” | h1_2 | h1_2 | “y” | h2_2 | h2_2 | “z” | b2 |
| | a3 | “x” | h1_3 | h1_3 | “y” | h2_4 | h2_4 | “z” | b4 |
| | a4 | “x” | h1_4 | h1_4 | “y” | h2_5 | h2_5 | “z” | b5 |
| Skewed | a5 | “x” | h1_5 | h1_5 | “y” | h2_5 | h2_5 | “z” | b5 |

The cost of the skew strategy is shown in Table 14, and a comparison of the costs of the non-skew and the skew strategies is shown in Table 15. Note that the special skew-handling strategy only used 12 lookups, and may have materialized more edges. So, in this case, the skew strategy may be better. Note that if the materialization of Edge 3 has been shared between two disjunct branches, then one lookup and five edge materializations may be avoided.

TABLE 14

| | | Number of edges |
|---|---|---|
| Operation | Lookups | materialized |
| 1 | 1 | 5 |
| 2 (skew) | 1 | 5 |
| 2 (non-skew) | 1 for build side | 5 for build side |
| | 1 for probe side | 8 for probe side |
| 3 (materialized skew) | 5 | 1 |
| Total | 12 | 24 |

TABLE 15

| | | Number of edges |
|---|---|---|
| Strategy | Lookups | materialized |
| Skew-aware | 12 | 24 |
| Not skew-aware | 27 | 15 |
| (index lookup join) | | |

In the querying technique, skew may be detected when deciding which constraint to pick for the next execution. As part of the constraint cost estimate, the cost of each node may be considered. If a node has an unmaterialized edge set, then the sum of the estimated cost of the unmaterialized edges may be considered. Based on the estimated cost of the unmaterialized edges relative to a threshold, the unmaterialized edge sets that are skewed and that should be handled differently may be determined. For example, the threshold for determining whether a <subject, predicate> or a <predicate, object> pair is skewed may be determined at runtime based on the cost of other edge-terms and constraints in the query. In the preceding example, note that skew detection occurred after the first operation.

In some embodiments, the querying technique includes cost modeling based on disjunct constraints. In particular, when a node is split by a disjunct, there may be execution sharing. This may be advantageous because, when a node is split, it may be materialized multiple times for different disjunct branches. For example, both of the nodes may point to the same materialized edge set and may have a bit vector for each branch of disjunct. Thus, because, during execution of the query or edge query shown in Table 16, the edge term for ‘pi’ may be materialized three times, the performance may be improved by sharing the materialization of the edge term.

TABLE 16

R1(a) :- Equal(a, “a1”)
R1(a) :- Equal(a, “a2”)
R1(a) :- Equal(a, “a3”)
R2(a,b) :- Equal(a, “p1”, b) R1(a)
R2(a,b)?

In an exemplary embodiment, the query plan is determined by accessing predefined cardinality information for a query (or estimates of edge cardinality), such as the number of edges or an edge count in an index of <subject, predicate> pairs, <predicate, object> pairs, subjects and/or objects. For example, the query Edge(“Bob Ridley” or “John Smith”, “followed by”, X)? and Edge(X, “lives in”, “New York City” or “Vernon, California”)? may have four query paths, including Edge(“Bob Ridley”, “followed by”, X)? and Edge(X, “lives in”, “New York City”)?, Edge(“Bob Ridley”, “followed by”, X)? and Edge(X, “lives in”, “Vernon, California”)?, Edge(“John Smith”, “followed by”, X)? and Edge(X, “lives in”, “New York City”)?, and Edge(“John Smith”, “followed by”, X)? and Edge(X, “lives in”, “Vernon, California”). These query paths may be performed in parallel and then joined.

However, as noted previously, the specific query paths may be changed at runtime or during execution as partial results allow the query plan to be dynamically modified. For example, a subject of “employees of company A” may have a predefined estimated cardinality information or size of 100, the predicate of “followed by” may have a predefined estimated cardinality information or size of 100 M, the predicate of “lives in” may have a predefined estimated cardinality information or size of 10 M, and an object of city, state in California may have a predefined estimated cardinality information or size of 500. Therefore, the initial query plan may start with a query plan that goes from left to right.

After materializing the subject of employees of company A, there may be two employees identified. The predefined estimated cardinality information for Bob Ridley may be more than 8 M followers, while John Smith may have 50. Therefore, it may make sense to break the query into subqueries for Bob Ridley and John Smith, and then to run the subquery with Bob Ridley starting from the predicate “lives in” and to continue running the remaining subqueries from left to right. However, the choice of query plan may depend on the shard (in embodiments with more than one shard). Thus, if a particular shard does not include Bob Ridley, there may not be a need to split the query into subqueries for this shard.

In some embodiments of the querying technique, after receiving a query, the storage system parses and compiles the query. Then, after looking up the predefined estimated cardinality information, the storage system may generate a constraint graph based on the nodes, edges, predicates and the associated predefined estimated cardinalities, and this constraint graph may be used to determine an initial query plan.

In general, the query plan may include one or more join plans to materialize nodes (such as <subject, predicate> pairs) on either side of a predicate in the constraint graph, including an index or nested lookup and/or a hash join. Based on the different join plans, a cost estimate for possible query plans may be determined. Then, the cheapest cost may be evaluated, and the constraint graph may be updated. Next, the query plan may be updated, e.g., by splitting the constraint graph, etc. This process may be repeated until the total result for the query is obtained.

In a hash join, a build side is materialized. Then, it is placed in a hash table to determine keys and values, and thus to materialize edges. Next, the probe side is materialized. For example, for each edge, the storage system may use a hash table to look up matching pairs.

Alternatively, in an index or nested lookup, the outer side (or left side) of a query or the inner side (or right side) or the query may be materialized. Using the outer side as an illustration, the outer side may be materialized. Then, for each edge in the outer side, a lookup constraint to the inner side may be added. Finally, all of the results may be output.

We now describe embodiments of a computer system for performing the querying technique and its use. FIG. 6 presents a block diagram illustrating a computer system 600 that performs method 400 (FIGS. 4 and 5), such as system 100 in FIG. 1. Computer system 600 includes one or more processing units or processors 610 (which are sometimes referred to as ‘processing modules’), a communication interface 612, a user interface 614, memory 624, and one or more signal lines 622 coupling these components together. Note that the one or more processors 610 may support parallel processing and/or multi-threaded operation, the communication interface 612 may have a persistent communication connection, and the one or more signal lines 622 may constitute a communication bus. Moreover, the user interface 614 may include: a display 616 (such as a touchscreen), a keyboard 618, and/or a pointer 620 (such as a mouse).

Memory 624 in computer system 600 may include volatile memory and/or non-volatile memory. More specifically, memory 624 may include: ROM, RAM, EPROM, EEPROM, flash memory, one or more smart cards, one or more magnetic disc storage devices, and/or one or more optical storage devices. Memory 624 may store an operating system 626 that includes procedures (or a set of instructions) for handling various basic system services for performing hardware-dependent tasks. Memory 624 may also store procedures (or a set of instructions) in a communication module 628. These communication procedures may be used for communicating with one or more computers and/or servers, including computers and/or servers that are remotely located with respect to computer system 600.

Memory 624 may also include multiple program modules, including: social-network module 630, administrator module 632, activity module 634, storage module 636, and/or encryption module 638. Note that one or more of these program modules (or sets of instructions) may constitute a computer-program mechanism, i.e., software.

During operation of computer system 600, users of a social network facilitated by social-network module 630 may set up and manage accounts using administrator module 632. Moreover, social-network module 630 may facilitate interactions among the users via communication module 628 and communication interface 612. These interactions may be tracked by activity module 634, such as viewing behavior of the users when viewing documents (and, more generally, content) provided in the social network that is implemented using social-network module 630.

Storage module 636 may store data associated with the social network in a graph database 640 that stores a graph 644 with nodes 646, edges 648 and predicates 650. When storage module 636 receives a query 654 from an application 652, storage module 636 may access predefined cardinality information 656 associated with query 654, and may identify query constraints 658 based on predefined cardinality information 656. Moreover, storage module 636 may determine an initial query plan 660 based on query constraints 658.

Next, storage module 636 may execute query 654 against graph database 640 storing graph 644 by providing at least a first of subqueries 662 and a query header 664 to a first of shards 642 of graph database 640. In some embodiments, storage module 636 optionally provides a second of subqueries 662 and a query header 666 to a second of shards 642 of graph database 640.

When executing subqueries 662, each of shards 642 independently and iteratively obtains intermediate or partial results 668 and determines one of updated query plans 670 until total results 672 for subqueries 662 are obtained. Then, shards 642 may return results 672 to storage module 636, which may optionally combine results 672 to obtain total result 674 for query 654. Note that desired information may be expressed in total result 674 within an associated structure of graph 644. In some embodiments, storage module 636 optionally provides at least a portion 676 of total result 674 to application 652.

Because information in computer system 600 may be sensitive in nature, in some embodiments at least some of the data stored in memory 624 and/or at least some of the data communicated using communication module 628 is encrypted using encryption module 638.

Instructions in the various modules in memory 624 may be implemented in a high-level procedural language, an object-oriented programming language, and/or in an assembly or machine language. Note that the programming language may be compiled or interpreted, e.g., configurable or configured, to be executed by the one or more processors.

Although computer system 600 is illustrated as having a number of discrete items, FIG. 6 is intended to be a functional description of the various features that may be present in computer system 600 rather than a structural schematic of the embodiments described herein. In practice, and as recognized by those of ordinary skill in the art, the functions of computer system 600 may be distributed over a large number of servers or computers, with various groups of the servers or computers performing particular subsets of the functions. In some embodiments, some or all of the functionality of computer system 600 is implemented in one or more application-specific integrated circuits (ASICs) and/or one or more digital signal processors (DSPs).

Computer systems (such as computer system 600), as well as electronic devices, computers and servers in system 100 (FIG. 1), may include one of a variety of devices capable of manipulating computer-readable data or communicating such data between two or more computing systems over a network, including: a personal computer, a laptop computer, a tablet computer, a mainframe computer, a portable electronic device (such as a cellular phone or PDA), a server and/or a client computer (in a client-server architecture). Moreover, network 112 (FIG. 1) may include: the Internet, World Wide Web (WWW), an intranet, a cellular-telephone network, LAN, WAN, MAN, or a combination of networks, or other technology enabling communication between computing systems.

System 100 (FIG. 1) and/or computer system 600 may include fewer components or additional components. Moreover, two or more components may be combined into a single component, and/or a position of one or more components may be changed. In some embodiments, the functionality of system 100 (FIG. 1) and/or computer system 600 may be implemented more in hardware and less in software, or less in hardware and more in software, as is known in the art.

While a social network and a graph database have been used as illustrations in the preceding embodiments, more generally the querying technique may be used to store and retrieve or query data associated with a wide variety of applications, services or systems, as well as a wide variety of types of databases. Moreover, the querying technique may be used in applications where the communication or interactions among different entities (such as people, organizations, etc.) can be described by a social graph. Note that the people may be loosely affiliated with a website (such as viewers or users of the website), and thus may include people who are not formally associated (as opposed to the users of a social network who have user accounts). Thus, the connections in the social graph may be defined less stringently than by explicit acceptance of requests by individuals to associate or establish connections with each other, such as people who have previously communicated with each other (or not) using a communication protocol, or people who have previously viewed each other's home pages (or not), etc. In this way, the querying technique may be used to expand the quality of interactions and value-added services among relevant or potentially interested people in a more loosely defined group of people.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A computer-system-implemented method for requesting desired information from a database, the method comprising:
receiving a query;
accessing predefined cardinality information associated with the query;
identifying query constraints based on the predefined cardinality information associated with the query;
determining an initial query plan based on the query constraints;
executing an initial query against the database based on the initial query plan;
revising the initial query and the initial query plan, based on partial results of the initial query, to produce a revised query and a revised query plan; and
executing the revised query against the database based on the revised query plan to obtain additional partial results.

2. The method of claim 1, further comprising:
further revising the revised query and the revised query plan, and further executing the revised query, until a total result for the query is obtained.

3. The method of claim 1, wherein:
the database stores a graph with nodes, edges between the nodes, and predicates to represent data; and
the query includes a subject, a predicate, and an object.

4. The method of claim 3, wherein:
the database provides constant-time access to the predefined cardinality information; and
the predefined cardinality information includes a number of nodes, edges and predicates in the graph that are associated with one or more of: the subject, the predicate, and the object.

5. The method of claim 1, wherein:
the database includes multiple shards;
the method further comprises:
splitting the query into subqueries; and
providing the subqueries to the shards, wherein a given shard receives at least a given subquery; and
each of the shards independently performs the operations of: determining the initial query plan, executing the initial query, revising the initial query, and executing the revised query.

6. The method of claim 1, wherein the query is a declarative query so that it expresses computational logic without expressing an associated control flow.

7. The method of claim 1, wherein the initial query plan and the revised query plan include one of: a hash join, and an index join.

8. An apparatus, comprising:
one or more processors;
memory; and
a program module, wherein the program module is stored in the memory and, during operation of the apparatus, is executed by the one or more processors to request desired information from a database, the program module including instructions for:
receiving a query;
accessing predefined cardinality information associated with the query;
identifying query constraints based on the predefined cardinality information associated with the query;
determining an initial query plan based on the query constraints;
executing an initial query against the database based on the initial query plan;
revising the initial query and the initial query plan, based on partial results of the initial query, to produce a revised query and a revised query plan; and
executing the revised query against the database based on the revised query plan to obtain additional partial results.

9. The apparatus of claim 8, wherein the program module further comprises instructions for further revising the revised query and the revised query plan, and further executing the revised query, until a total result for the query is obtained.

10. The apparatus of claim 8, wherein:
the database stores a graph with nodes, edges between the nodes, and predicates to represent data; and
the query includes a subject, a predicate, and an object.

11. The apparatus of claim 10, wherein:
the database provides constant-time access to the predefined cardinality information; and
the predefined cardinality information includes a number of nodes, edges and predicates in the graph that are associated with one or more of: the subject, the predicate, and the object.

12. The apparatus of claim 8, wherein:
the database includes multiple shards;
the program module further comprises instructions for:
splitting the query into subqueries; and
providing the subqueries to the shards, wherein a given shard receives at least a given subquery; and
each of the shards independently performs the operations of: determining the initial query plan, executing the initial query, revising the initial query, and executing the revised query.

13. The apparatus of claim 8, wherein the query is a declarative query so that it expresses computational logic without expressing an associated control flow.

14. The apparatus of claim 8, wherein the initial query plan and the revised query plan include one of: a hash join, and an index join.

15. A system, comprising:
a first processing module comprising a first non-transitory computer-readable medium storing first instructions that, when executed, cause the system to:
receive a query;
access predefined cardinality information associated with the query; and
identify query constraints based on the predefined cardinality information associated with the query; and
a second processing module comprising a second non-transitory computer readable medium storing second instructions that, when executed, cause the system to:
determine an initial query plan based on the query constraints;
execute an initial query against the database based on the initial query plan;
revise the initial query and the initial query plan, based on partial results of the initial query, to produce a revised query and a revised query plan; and
execute the revised query against the database based on the revised query plan to obtain additional partial results.

16. The system of claim 15, wherein the second instructions, when executed, further cause the system to: further revise the revised query and the revised query plan, and further execute the revised query, until a total result for the query is obtained.

17. The system of claim 15, wherein:
the database stores a graph with nodes, edges between the nodes, and predicates to represent data; and
the query includes a subject, a predicate, and an object.

18. The system of claim 17, wherein:
the database provides constant-time access to the predefined cardinality information; and
the predefined cardinality information includes a number of nodes, edges and predicates in the graph that are associated with one or more of: the subject, the predicate, and the object.

19. The system of claim 15, wherein:
the database includes multiple shards;
the first instructions, when executed, further cause the system to:
split the query into subqueries; and
provide the subqueries to the shards, wherein a given shard receives at least a given subquery; and
each of the shards independently performs the operations of:
determining the initial query plan, executing the initial query, revising the initial query, and executing the revised query.

20. The system of claim 15, wherein the query is a declarative query so that it expresses computational logic without expressing an associated control flow.
